(19) United States
(12) Patent Application Publication
(10) Pub. No.: US 2019/0340511 A1
(43) Pub. Date: Nov. 7, 2019

(54) SPARSITY CONTROL BASED ON HARDWARE FOR DEEP-NEURAL NETWORKS

(71) Applicant: Intel Corporation, Santa Clara, CA (US)

(72) Inventors: Sofiane Yous, Dublin (IE); Hamza Yous, Dublin (IE)

(73) Assignee: Intel Corporation, Santa Clara, CA (US)

(21) Appl. No.: 16/447,216

(22) Filed: Jun. 20, 2019

(51) Int. Cl. G06N 3/08; G06N 5/04; G06N 3/04; G06F 17/15

(52) U.S. Cl. CPC G06N 3/082; G06F 17/15; G06N 3/04; G06N 5/04

(57) ABSTRACT

Systems, methods, computer program products, and apparatuses to transform a weight space of an inference model to increase the compute efficiency of a target inference platform. A density of a weight space can be determined, and a transformation parameter derived based on the determined density. The weight space can be re-ordered based on the transformation parameter to balance the compute load between the processing elements (PEs) of the target platform, and as such, reduce the idle time and/or stalls of the PEs.

### BACKGROUND

Convolutional neural networks (CNNs) have become a dominant technique in the field of machine learning. Many conventional CNNs have complex architectures with many layers and parameters. Thus, they are often referred to as deep-neural networks. Deployment of such deep-neural networks into memory and compute constrained environments, such as, embedded devices, is limited due to the large size of the networks and due to the amount of memory and computational resources required to process the network and generate an inference.

Thus, the ability to push inference generation operations to embedded devices, to the edge, to mobile devices, or to other memory and compute constrained devices is limited.

### BRIEF DESCRIPTION OF THE DRAWINGS

FIG. 1 illustrates a computing system.

FIG. 2 illustrates a target compute system.

FIG. 3 illustrates an operational example of the target compute system of FIG. 2.

FIGS. 4A and 4B illustrate weight space mappings.

FIGS. 5A and 5B illustrate transformed weight space mappings.

FIG. 6 illustrates a logic flow.

FIG. 7 illustrates a target compute system.

FIGS. 8A and 8B illustrate transformed weight space mappings for groups of PEs.

FIGS. 9A, 9B, and 9C illustrate dependency graphs for an inference model.

FIG. 10 illustrates re-ordering of weights of a given layer and re-ordering of channels of kernels of a dependent layer to compensate for the re-orderings of the weights.

FIGS. 11A and 11B illustrate re-ordering distributions.

FIGS. 12A and 12B illustrate sparsity maps.

FIGS. 13A and 13B illustrate packed weight space maps.

FIG. 14 illustrates a storage medium.

FIG. 15 illustrates a computing system.

### DETAILED DESCRIPTION

Embodiments disclosed herein provide for adapting layers, and particularly weights, of a neural network (NN) model (e.g., a CNN) to a pattern without the need for retraining or consideration of the activation function of the nodes in the layer. In general, the present disclosure provides to transform (or rearrange) the weights of a CNN layer where the behavior of the layer before the transformation is identical to the behavior of the layer after the transformation. Said differently, the present disclosure provides to transform the weight space such that sparsity of the weights (e.g., due to pruning, or the like) is adapted or modeled to a particular pattern without impact on the behavior of the CNN.

In some examples, weights within a layer are transformed based on hardware with which the CNN is to be executed. More particularly, the weights can be transformed (or rearranged) such that the sparsity of the weight space is adapted to a pattern associated with the hardware compute model in order to increase the compute efficiency. It is noted, that the present disclosure provides for transforming the weight space to fit a pattern, which is different than merely skipping ineffectual computations (e.g., weights with a zero value, weights with a near zero value, rectified linear unit (ReLU) activation functions, etc.). Furthermore, the present disclosure is different than merely pruning the network, which leads to networks with sparsity. That is, merely pruning ineffectual weights can lead to performance loss in the CNN computation as sparse weight matrices lose the regular structure of dense matrices. One reason for this is the computational overhead required to decode the sparse format of the network at runtime. A second reason is to balance the compute load between the processing elements (PEs) and, as such, reduce the idle time or stalls.

The present disclosure provides for transforming a network weight space to rearrange the sparsity of the layers of a network in order to balance the compute of the processing element of the inference device. Thus, models executed by systems described herein can leverage model pruning techniques to reduce the computational overhead while not incurring the computational penalty associated with sparsely packed networks and idle time for processing elements.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations may be referred to in terms, such as adding or comparing, which are commonly associated with logical operations. Useful machines for performing these logical operations may include general purpose digital computers as selectively activated or configured by a computer program that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

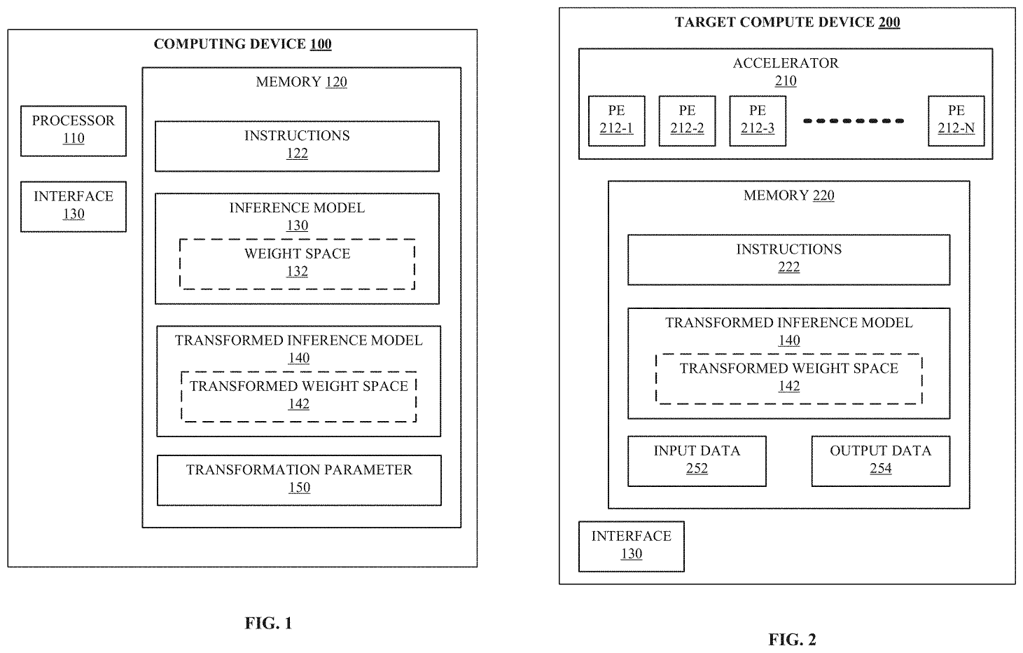

FIG. 1 illustrates an embodiment of a computing device 100. The computing device 100 is representative of any number and type of devices, arranged to transform the weight space of an inference model to a particular pattern. The computing device 100 includes a processor 110, memory 120, and interface 130.

The processor 110 may include circuity or processor logic, such as, for example, any of a variety of commercial processors. In some examples, the processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability. In some examples, the processor 110 may be an application specific integrated circuit (ASIC) or a field programmable integrated circuit (FPGA). In some implementations, the processor 110 may be circuitry arranged to perform computations related to artificial intelligence (AI), sometimes referred to as an accelerator, or AI accelerator.

The memory 120 may include logic, a portion of which includes arrays of integrated circuits, forming non-volatile memory to persistently store data or a combination of non-volatile memory and volatile memory. It is to be appreciated, that the memory 120 may be based on any of a variety of technologies. In particular, the arrays of integrated circuits included in memory 120 may be arranged to form one or more types of memory, such as, for example, dynamic random access memory (DRAM), NAND memory, NOR memory, or the like.

Interface 130 may include logic and/or features to support a communication interface. For example, the interface 130 may include one or more interfaces that operate according to various communication protocols or standards to communicate over direct or network communication links. Direct communications may occur via use of communication protocols or standards described in one or more industry standards (including progenies and variants). For example, the interface 130 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. In some examples, interface 130 may be arranged to support wireless communication protocols or standards, such as, for example, Wi-Fi, Bluetooth, ZigBee, LTE, 5G, or the like.

Memory 120 stores instructions 122, as well as inference model 130, transformed inference model 140, and transformation parameter 150. In general, inference model 130 can be any of a of a variety of inference models, such as, a neural network (NN), and particularly a convolutional neural network (CNN). Inference model 130 includes layer of weights, generally referred to herein as the “weight space” 132.

Processor 110 can execute instructions 122 to generate transformed inference model 140 from inference model 130, based in part, on transforming the weight space 132, resulting in transformed weight space 142. In general, processor 110 can execute instructions 122 to transform weight space 132 of inference model 130 based on transformation parameter 150 to correspond to a particular pattern, or to suit a particular compute structure, such as, a compute structure of a target compute device.

FIG. 2 illustrates an example target compute device 200. The target compute device 200 is representative of any number and type of devices, arranged to execute transformed inference model 140. The target compute device 200 includes an accelerator 210 and memory 220.

In general, accelerator 210 includes circuity or processor logic arranged to execute instructions for processing neural networks. For example, accelerator 210 can include a number of distinct processing elements 212 (e.g., processor cores, or the like) arranged to process, in parallel, any of a variety of mathematical operations. Accelerator 210 can include any number of PEs 212. For example, this figure depicts PE 212-1, PE 212-2, PE 212-3 through PE 212-N. PEs 212 can execute multiplication and accumulation (MAC) operations. Accelerator 210 could be implemented by a multi-core processor, by an ASIC (or FPGA) arranged to execute specific operations related to inference models.

Memory 220 stores instructions 222, transformed inference model 140, input data 252 and output data 254. Accelerator 210 can execute instructions 222 to generate output data 254 from executing transformed inference model 140 with input data 252. In general, accelerator 210, and particularly PEs 212 of accelerator 210, can processes a portion of the input data 252 to generate a portion of the output data 254.

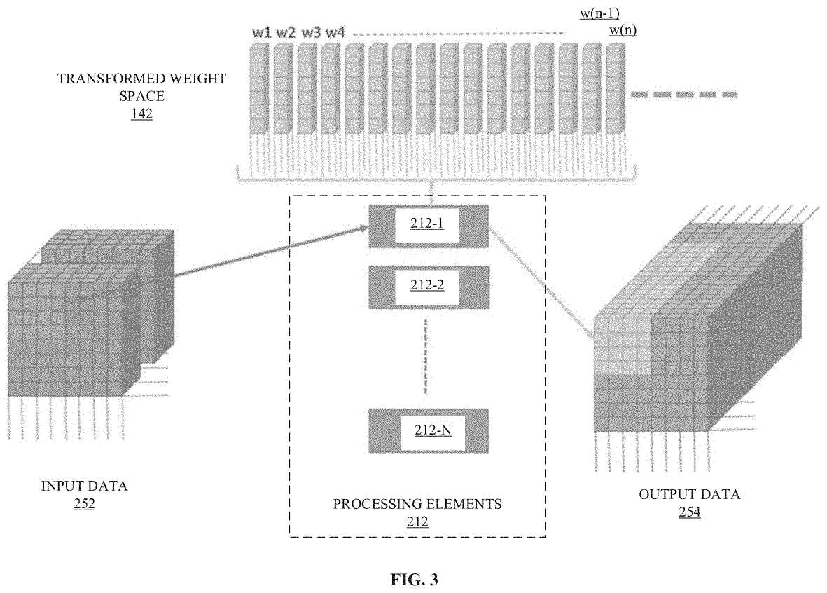

For example, FIG. 3 illustrates PEs 212 from target compute device 200 generating output data 254 from input data 252. As depicted, input data 252 and output data 254 are tensors, or matrixes. During operation of target compute device 200, each PE 212 processes a portion of the input data 252 tensor each processing cycle to generate a number of output data 254 tensor having a number of channels equivalent to the input. For example, at each cycle every PE 212 can process a portion of the input data 252 tensor (e.g. 4×4×N or 1×16×N, where N is the number of input channels) and generate a number of channels with equivalent size to the input (e.g. 4×4×16 in case of 1×1 convolution) using a consequent number of kernels, or weights 142 (16 in this case, each of which is 1×1××N size).

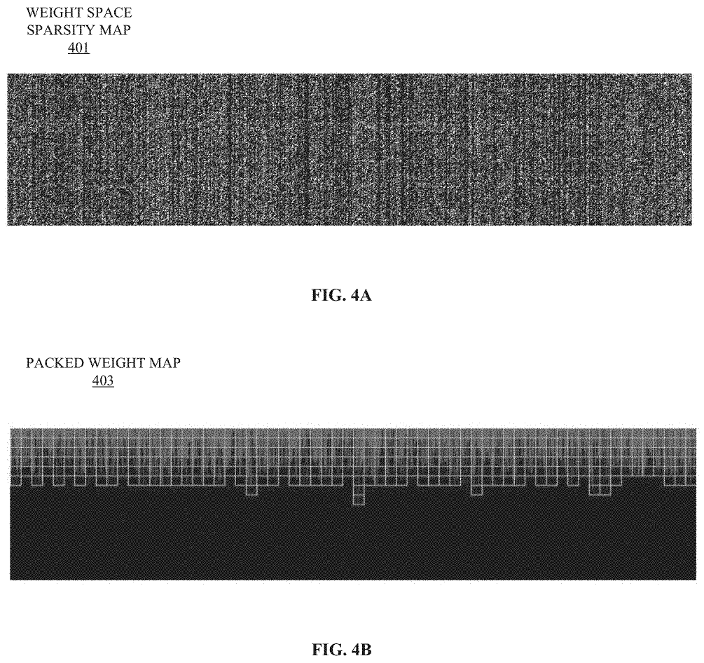

It is to be appreciated, that processing a convolution requires splitting the workload between all the PEs 212, which collaborate together to process the same input data 252 tensor and generate the output data 254 tensor, as depicted in FIG. 3. The present disclosure can be implemented to generate transformed weight space 142 for any of a variety of NN or CNN processing schemes. Said differently, the present disclosure is not affected by how compute is spread across the PEs 212 or how PEs 212 cooperate. For example, NN accelerators supporting sparsity (e.g., sparse processing of activations and weights) receive packed sparse data and corresponding sparsity maps (bit maps), which allow access to the non-zero elements for processing. FIGS. 4A and 4B illustrate an example weight space sparsity map 401 and packed weight map 403, respectively.

Referring to FIG. 4A, in the weight space sparsity map 401, each dark area (or pixel) corresponds to a zero valued weight in the original weight space 132 while the light areas (or pixels) correspond to non-zero weights in the original weight space 132. Referring to FIG. 4B, in the packer weight map 403 the width of each green box refers to the group of kernels to be processed in parallel (e.g., group or weights to be processed in a single cycle, or the like) to produce a consequent number of output channels (e.g., one output channel per PE 212, or the like), which are 16 in this example. Furthermore, the height of the green boxes refers to the number of input channels (same for input tensor and weights) which can be processed in one compute cycles. The packed weight map 403 can be representative of the complexity of the compute operation for the model 130.

In general, target compute device 200 can “compute” output data 254 given input data 252 and an inference model (e.g., model 130, transformed model 140, or the like). Compute for a CNN includes a convolution operation, which can be defined as the matrix multiplication between the weight data W and the input activation X followed by addition to bias B, resulting in the output activation Y. Equation 1 defines compute for a CNN.

Y=W×X+B 1

The weight data W could be considered a group of kernels W={w₁, w₂, w₃, . . . wₖ}, where k is the number of output channels. The convolution of the input activation with each weight element wᵢ results a single output channel yⁱ, defined by Equation 2

yᵢ=wᵢ×X+bᵢ 2

Accordingly, the resulting convolution output Y can be defined as the set of the outputs Y={y₁, y₂, y₃, . . . yₖ}. The set of output channels can be grouped in three-dimensional volume to be processed as an input for the next layer.

As detailed above, computing device 100 can be arranged to generate transform weight space 142 from weight space 132. More specifically, processor 110 in executing instructions 122 can transform (or re-order) weight space 132 into transformed weight space 142. Defining the re-ordering operation as a transformation T_{θ}{} of the weight W^{l} for the layer l with the parameters θ. Such a transformation changes the operational order the weights as shown in Equation 3:

T_{θ}{W^{l}}={w_{θ(1)}^{l}, w_{θ(2)}^{l}, w_{θ(3)}^{l}, . . . w_{θ(k)}^{l}} 3

Consequently, the convolution of the input X with the transformed weights T_{θ}{W^{l}} only changes the order of the output activation maps. To compensate this change, for each transformation in layer l, processor 110 in executing instructions 122 can apply a corresponding transformation T′_{θ}{} with the same parameters θ to the channels of weights of the next layer (e.g., layer l+1). More particularly, in executing instructions 122, processor 110 can manipulate each of the weight elements of the next layer (e.g., layer l+1) independently based on the same ordering parameter θ, defined by Equation 4.

T′_{θ}{W^{l+1}}={T′_{θ}{w₁^{l+1}}, T′_{θ}{w₂^{l+1}}, T′_{θ}{w₃^{l+1}}, . . . , T′_{θ}{w_{M}^{l+1}}} 4

As described in FIGS. 4A and 4B, the output of the layer l+1 obtained by the convolution of the output Y¹ with the weight W^{l+1} can also be obtained by the convolution of the input X with the combination of the two transformations T_{θ}{} and T′_{θ}{}, expressed by Equation 5.

Y^{l+1}=W^{l+1}×(W^{l}×X+B^{l})+B^{l+1}=T′_{θ}{W^{l+1}}×(T_{θ}{W^{l}}×X+T_{θ}{B^{l}})+B^{l+1} 5

Defining the sparsity of a weights W^{l} as a binary map M^{l} with size (K×C×R×S), where C and K are the input and output channel sizes, respectively; and where R×S is defined as the spatial size of each weight w^{l}. Furthermore, the present disclosure defines a density function d to derive the number of non-zero elements of weight space 132, reflected in Equation 6.

d(k)=Σ_{c}ΣᵣΣₛM(k, c, r, s) 6

Processor 110 in executing instructions 12 can derive the number of non-zero elements of weight space 132 based on the density function d of Equation 6. The transformation parameter θ can be defined as the indexes from the sorted density function d. With some examples, the density function d for deriving the transformation parameters can be based in part on the hardware specifications for the target compute device 200. That is, the hardware features of the target compute device 200 (e.g., number of PEs 212, or the like) can be utilized to craft the density function and determine the transformation parameter θ.

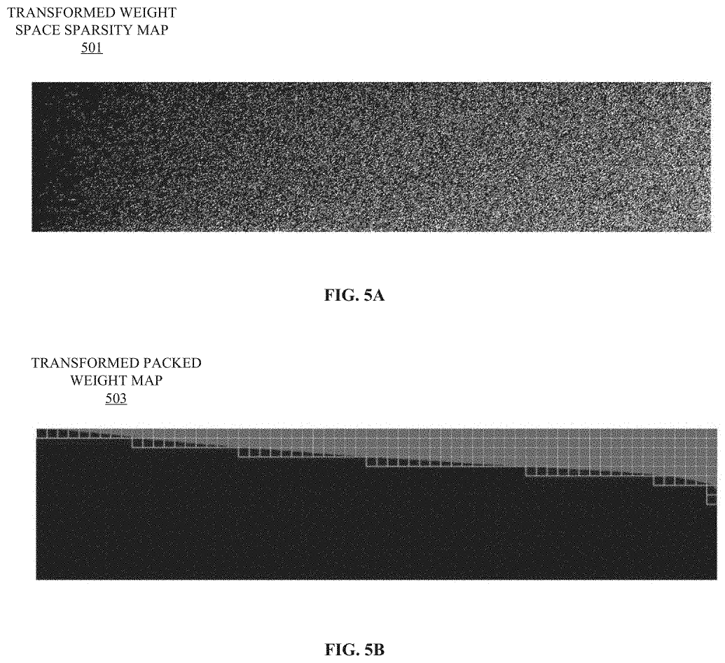

FIGS. 5A and 5B illustrate an example transformed weight space sparsity map 501 and transformed packed weight map 503, respectively. Contrasting maps 501 and 503 to maps 401 and 403 shows a reduction in the number of PE compute cycles from 373 to 223, representing a theoretical savings of 40% in compute resources and time. Referring to FIGS. 5A and 5B, a layer (or tensor) of weight space 132 with the size of (K×C×R×S) is reshaped to a two dimensional representation with the size (C*R*S×K). In the transformed weight space 142, the original sparse weights are reordered over the output channels K to redistribute them according to their density in order to balance the load between the PEs and reduce the idle time.

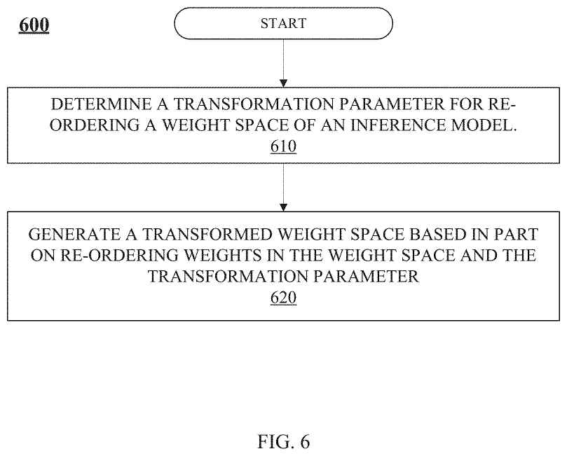

FIG. 6 illustrates a logic flow 600. The logic flow 600 may be representative of operation executed by processor 110 in executing instructions 122 to reorder weight space 132 into transformed weight space 142. Logic flow 600 can begin at block 610. At block 610 “determine a transformation parameter for re-ordering a weight space of an inference model” computing device 100 can determine transformation parameter 150. For example, in executing instructions 122 processor 110 can determine transformation parameter 150 based in part on the density of weight space 132, such as, based in part on Equation 6 above.

Continuing to block 620 “generate a transformed weight space based in part on re-ordering weights in the weight space and the transformation parameter” computing device 100 can re-order weight space 132 based on transformation parameter 150 to generate transformed weight pace 142. For example, in executing instructions 122 processor 110 can generate transformed weight space 142 from layers in weight space 132 based on Equations 3 and 4 above.

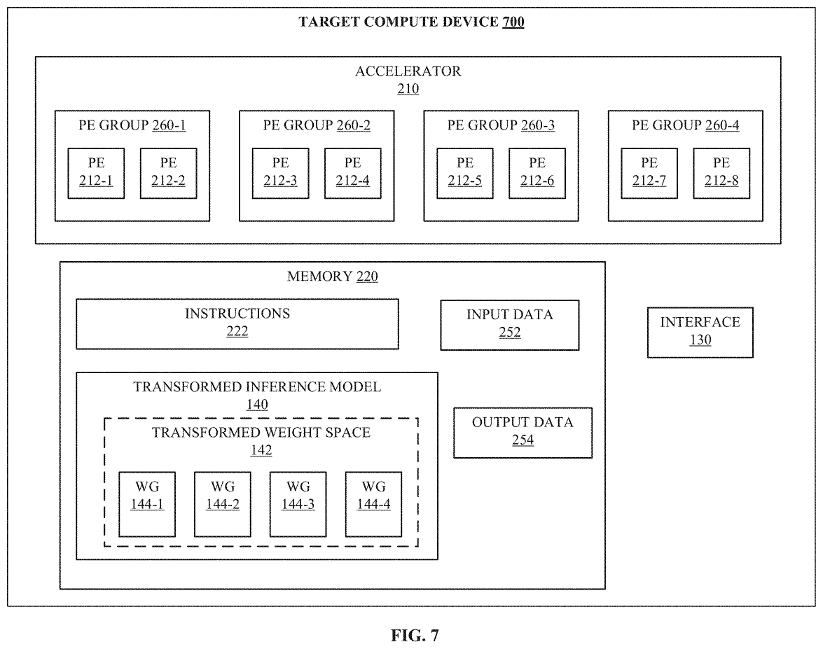

With some examples, a target compute device can have groupings of PEs. For example, FIG. 7 illustrates a target compute device 700 with 4 PE groups 260, specifically, PE group 260-1, 260-2, 260-3, and 260-4. PEs 212 are divided among PE groups 260. PE groups need not be located within the same target compute device. For example, multiple distinct target compute devices 200 can be provided to generate an inference from transformed inference model 140, where each device 200 corresponds to a PE group 260. Computing device 100 can transform weight space 132 of inference model 130 into separate weight spaces groups 144-J, where J is the number of PE groups 260. For example, this figure depicts weight space groups 144-1, 144-2, 144-3, and 144-4.

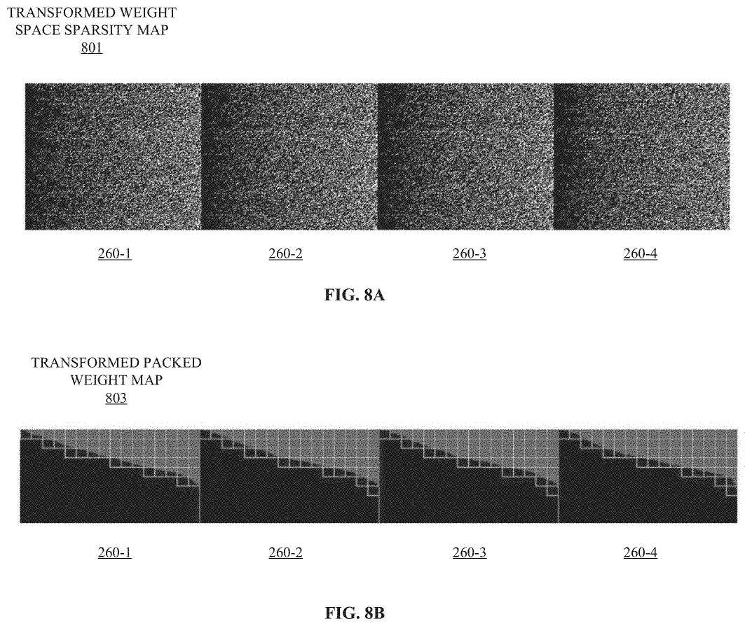

FIGS. 8A and 8B illustrate an example transformed weight space sparsity map 801 and transformed packed weight map 803, respectively, for 4 separate weight space groups, to be executed by PE groups 260 (e.g., 260-1, 260-2, 260-3, and 260-4, or the like).

In some examples, inference model 130 may be sequential (e.g., an alexNET CNN, a VGG CNN, or the like) and thus only have dependencies between sequential layers of the weights space. As such, a transformation T of one layer of the weight space 130 only requires a transformation T′ of the subsequent layer. However, for inference models 130 with branching structures (e.g., a residual neural network (ResNet), or the like), computing device 100 can transform further layers of weight space 132.

For example, the third convolution of one block in a ResNet 50 inference model has a dependency on the all the thirds and the first convolutions of all the blocks in a given layer. This is because of the element-wise addition between the output channels of the third convolution of a residual block and the identity output channel. As such, computing device 100 (or processor 110 in executing instructions 122) can transform weight space 132 based in part on the overall network structure. With some examples, some layers of the weight space 132 may not be transformed to maintain the network coherence due to the dependencies. With some examples, in executing instructions 122 processor 110 can transform weight space 132 for branching network structures based in part on a dependency graph for the layers of weight space 132. Dependency graph can be generated and/or based on inter-layer dependencies as well as global dependency between layers of the weight space 132 to determine processing required at every layer.

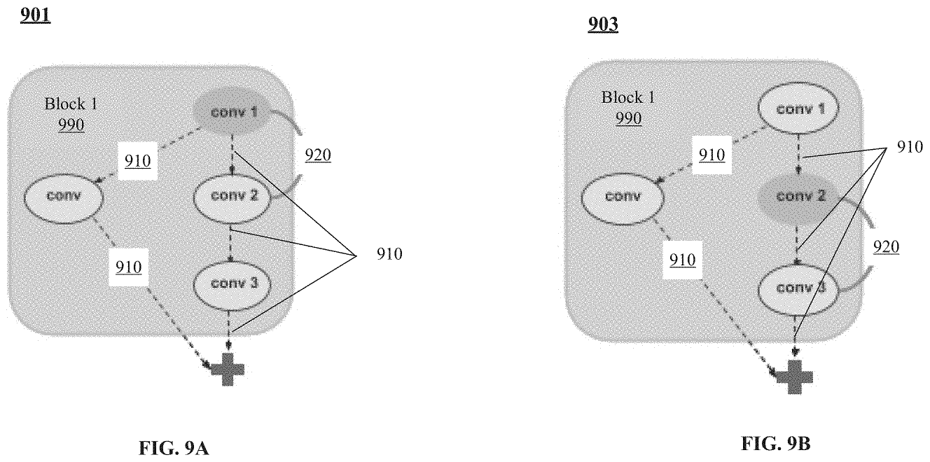

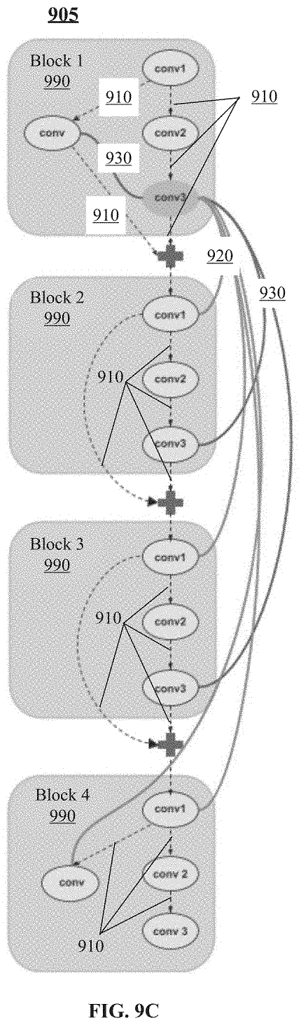

FIGS. 9A, 9B, and 9C illustrate dependency graphs 901, 903, and 905, respectively. Dependency graphs 901, 903, and 905 correspond to dependency graphs for first, second, and third convolutions of a first layer of a weight space 132, respectively. These figures depict convolutions for various blocks 990 of a CNN and illustrate compute dependencies 910 (black dashed lines) as well as transpose dependencies 920 (red lines) and transformation dependencies 930 (blue lines). Dependency graphs 901 and 903 indicate that the transpose dependencies 920 require only an equivalent transformation T′_{θ} in the first and second convolutions. However, the third layers have more dependencies as illustrates by transformation dependencies 930. Given the dependencies illustrated in the graphs 905, any transformation θ on any third convolution requires the same transformation be applied to all the third convolutions in the layer as well as the bottleneck convolution. This is in addition to the transpose transformation of the first convolution in the second and the third blocks of the current layer with the first convolution of the first block of the next layer.

Accordingly, all dependent layers must be transformed using the same transformation parameter θ. With some examples, computing device 100 (or processor 110 in executing instructions 122) can select the transformation parameter 150 as the transformation parameter that results in the minimal number of storage elements needed in target compute device 200. In some example, processor 110 in executing instructions 122 can generate transformed weight space 142 based in part on adding an identity convolution operation at the end of every series of sequential operations. For example, processor 110 in executing instructions 122 can add an identity convolution after the full network or after a branch in an inception layer (e.g., a googleNet CNN, a ResNet CNN, or the like). As another example, processor 110 in executing instructions 122 can add an identity convolution to any N−1 branches of the network to align layers to the remaining branch(s).

FIG. 10 illustrates a flow diagram 1000 depicting kernel (or weight) re-ordering and compensation. Said differently, flow diagram 1000 illustrates re-ordering the channels of the dependent layers of a network. As described herein, re-ordering kernels within one layer requires re-ordering the channels within the following (or subsequent) layer. This figure depicts a first layer 1001 (layer i) and a subsequent layer 1003 (layer i+1). Example kernel re-orderings are done in the first layer 1001, depicted at re-ordering operations 1012 and 1014. Due to kernel re-ordering operations 1012 and 1014 done in layer 1001; channel re-ordering operations 1022 and 1024 are done in layer 1003 to compensate for the kernel re-ordering operations.

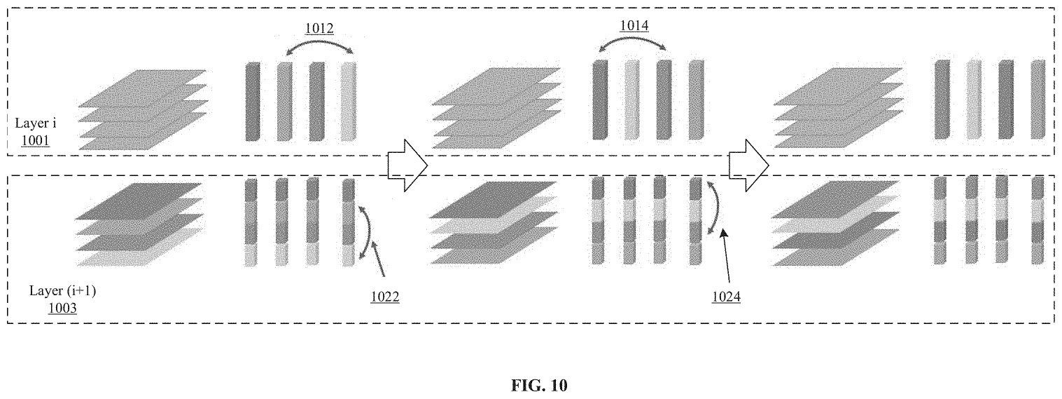

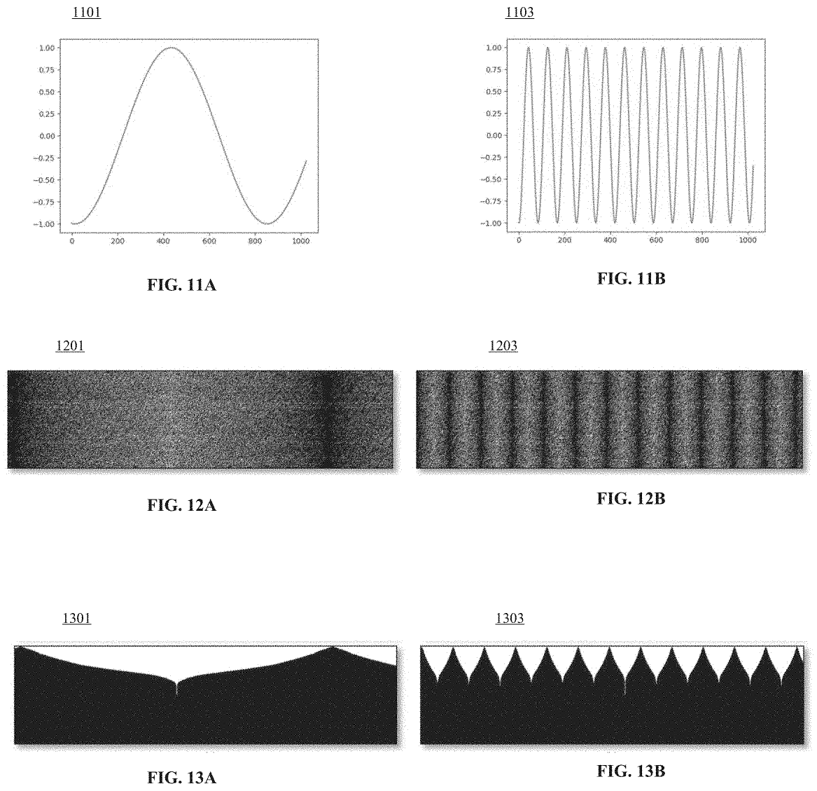

In general, the present disclosure can be applied to re-order weights in a layer of an inference model to suit (or based on) any of a variety of hardware accelerators. Said differently, weights in a layer of an inference model can be re-ordered to have any of a variety of distributions. For example, FIGS. 11A and 11B depict a first distribution 1101 and a second distribution 1103, respectively. FIGS. 12A and 12B depict re-ordered sparsity maps 1201 and 1203; corresponding to weights in a layer of an inference model re-ordered according to distributions 1101 and 1103 respectively. Lastly, FIGS. 13A and 13B illustrate packed weight space mappings 1301 and 1303; corresponding to weights re-ordered based on mappings distributions 1101 and 1103, respectively

In general, re-ordering based on a given distribution can be done by (1) generating a number of samples from the target distribution and the density function; (2) deriving the density of the current sparsity map; (3) sorting both densities; (4) deriving a transformation vector of the target; and (5) re-ordering the packed-weights and sparsity maps following the inverse transformation based on the derived transformation vector.

It is noted that the present disclosure can provide for a more simplified hardware design that avoids complexities added to handle the irregularity and randomness of weight ordering in inference models, which are typically added in conventional models. Furthermore, the present disclosure can be applied to any of a variety of accelerators and generalized to any spatial compute process where the sparsity is a factor in the compute.

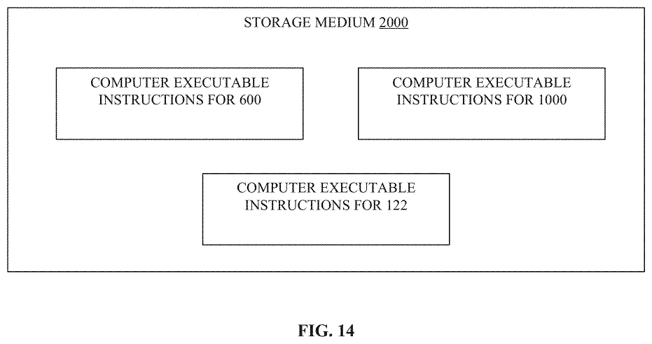

FIG. 14 illustrates an embodiment of a storage medium 2000. Storage medium 2000 may comprise any non-transitory computer-readable storage medium or machine-readable storage medium, such as an optical, magnetic or semiconductor storage medium. In various embodiments, storage medium 2000 may comprise an article of manufacture. In some embodiments, storage medium 2000 may store computer-executable instructions, such as computer-executable instructions 122 and/or instructions to implement one or more of logic flows or operations described herein, such as with respect to logic flow 600 of FIG. 6 or flow diagram 1000 of FIG. 10. Similarly, the storage medium 2000 may store computer-executable instructions for equations 1-6 above. The storage medium 2000 may further store computer-executable instructions for inference models described herein, such as inference model 130 and/or transformed inference model 140 (including weight spaces of the models). The neural network 104 (and constituent components, including any training, described herein). Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

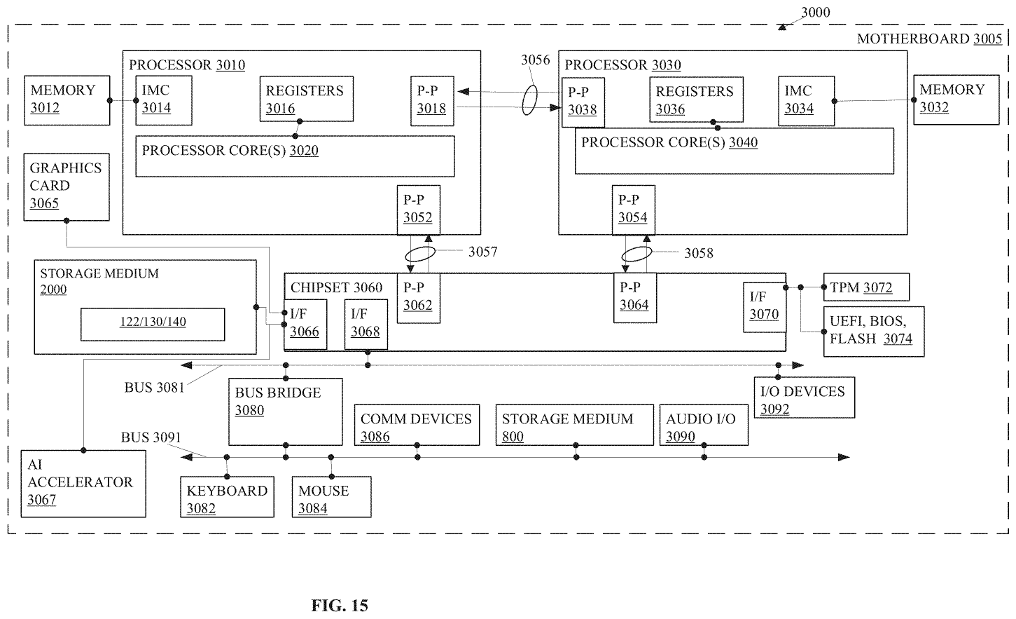

FIG. 15 illustrates an embodiment of an exemplary computing architecture 3000 that may be suitable for implementing various embodiments as previously described. In various embodiments, the computing architecture 3000 may comprise or be implemented as part of an electronic device. In some embodiments, the computing architecture 3000 may be representative, for example, of a computer system that implements one or more components of devices 100 of FIG. 1 or 200 of FIG. 2. The embodiments are not limited in this context. More generally, the computing architecture 3000 is configured to implement all logic, systems, logic flows, methods, equations, apparatuses, and functionality described herein and with reference to FIGS. 1-14.

As used in this application, the terms “system” and “component” and “module” are intended to refer to a computer-related entity, either hardware, a combination of hardware and software, software, or software in execution, examples of which are provided by the exemplary computing architecture 3000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 3000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 3000.

As shown, the computing architecture 3000 comprises a processing unit 3004, a system memory 3006 and a system bus 3008. The processing unit 3004 (also referred to as a processor circuit) can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 3004. In at least one embodiment, the processing unit 3004 corresponds to the processor circuits 110 and/or accelerator 210 while memory 3006 can correspond to memory 120 and/or memory 220.

The system bus 3008 provides an interface for system components including, but not limited to, the system memory 3006 to the processing unit 3004. The system bus 3008 can be any of several types of bus structure that may further interconnect to a memory bus (with or without a memory controller), a peripheral bus, and a local bus using any of a variety of commercially available bus architectures. Interface adapters may connect to the system bus 3008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 3006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), bulk byte-addressable persistent memory (PMEM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment, the system memory 3006 can include non-volatile memory 3010 and/or volatile memory 3012. A basic input/output system (BIOS) can be stored in the non-volatile memory 3010.

The computer 3002 may include various types of computer-readable storage media in the form of one or more lower speed memory units, including an internal (or external) hard disk drive (HDD) 3014, a magnetic floppy disk drive (FDD) 3016 to read from or write to a removable magnetic disk 3018, and an optical disk drive 3020 to read from or write to a removable optical disk 3022 (e.g., a compact disc read-only memory (CD-ROM) or digital versatile disc (DVD). The HDD 3014, FDD 3016 and optical disk drive 3020 can be connected to the system bus 3008 by a HDD interface 3024, an FDD interface 3026 and an optical drive interface 3028, respectively. The HDD interface 3024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 3010, 3030, including an operating system 3030, one or more application programs 3032, other program modules 3034, and program data 3036. In one embodiment, the one or more application programs 3032, other program modules 3034, and program data 3036 can include, for example, the various applications and/or components of FIGS. 1-10.

A user can enter commands and information into the computer 3002 through one or more wire/wireless input devices, for example, a keyboard 3038 and a pointing device, such as a mouse 3040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 3004 through an input device interface 3042 that is coupled to the system bus 3008, but can be connected by other interfaces such as a parallel port, IEEE 1394 serial port, a game port, a USB port, an IR interface, and so forth.

A monitor 3044 or other type of display device is also connected to the system bus 3008 via an interface, such as a video adaptor 3046. The monitor 3044 may be internal or external to the computer 3002. In addition to the monitor 3044, a computer typically includes other peripheral output devices, such as speakers, printers, and so forth.

The computer 3002 may operate in a networked environment using logical connections via wire and/or wireless communications to one or more remote computers, such as a remote computer 3048. In various embodiments, one or more migrations may occur via the networked environment. The remote computer 3048 can be a workstation, a server computer, a router, a personal computer, portable computer, microprocessor-based entertainment appliance, a peer device or other common network node, and typically includes many or all of the elements described relative to the computer 3002, although, for purposes of brevity, only a memory/storage device 3050 is illustrated. The logical connections depicted include wire/wireless connectivity to a local area network (LAN) 3052 and/or larger networks, for example, a wide area network (WAN) 3054. Such LAN and WAN networking environments are commonplace in offices and companies, and facilitate enterprise-wide computer networks, such as intranets, all of which may connect to a global communications network, for example, the Internet.

When used in a LAN networking environment, the computer 3002 is connected to the LAN 3052 through a wire and/or wireless communication network interface or adaptor 3056. The adaptor 3056 can facilitate wire and/or wireless communications to the LAN 3052, which may also include a wireless access point disposed thereon for communicating with the wireless functionality of the adaptor 3056.

When used in a WAN networking environment, the computer 3002 can include a modem 3058, or is connected to a communications server on the WAN 3054, or has other means for establishing communications over the WAN 3054, such as by way of the Internet. The modem 3058, which can be internal or external and a wire and/or wireless device, connects to the system bus 3008 via the input device interface 3042. In a networked environment, program modules depicted relative to the computer 3002, or portions thereof, can be stored in the remote memory/storage device 3050. It will be appreciated that the network connections shown are exemplary and other means of establishing a communications link between the computers can be used.

The computer 3002 is operable to communicate with wire and wireless devices or entities using the IEEE 3002 family of standards, such as wireless devices operatively disposed in wireless communication (e.g., IEEE 1202.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 1202.11x (a, b, g, n, etc.) to provide secure, reliable, fast wireless connectivity. A Wi-Fi network can be used to connect computers to each other, to the Internet, and to wire networks (which use IEEE 1202.3-related media and functions).

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

The following examples pertain to further embodiments, from which numerous permutations and configurations will be apparent.

In addition, in the foregoing, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

### Example 1

An apparatus, comprising: a processor circuit; and memory coupled to the processor circuit, the memory to store instructions that when executed by the processor circuit cause the processor circuit to: determine a transformation parameter for re-ordering a weight space of an inference model; and generate a transformed weight space based in part on re-ordering weights in the weight space and the transformation parameter.

### Example 2

The apparatus of example 1, the instructions when executed by the processor cause the processor to determine the transformation parameter based in part on a density of the weight space.

### Example 3

The apparatus of example 2, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

### Example 4

The apparatus of example 3, wherein the transformed weight space has a size (C*R*S×K), which is less than the size of the weight space.

### Example 5

The apparatus of example 1, wherein the re-ordering is defined as T_{θ}{W^{l}}={w_{θ(1)}^{l}, w_{θ(2)}^{l}, w_{θ(3)}^{l}, . . . , w_{θ(k)}^{l}} wherein w is a layer l of weights in the weight space and θ is the transformation parameter.

### Example 6

The apparatus of example 5, wherein the re-ordering changes the operational order of weights in a first layer of the weight space.

### Example 7

The apparatus of example 6, wherein the re-ordering further changes the operational order of channels in a second layer of the weight space based in part on the transformation parameter and the re-ordering of the operational order of the weights in the first layer of the weight space.

### Example 8

The apparatus of example 7, wherein the re-ordering further changes the operational order of channels in a third layer of the weight space based in part on the transformation parameter and the re-ordering of the operational order of the weights in the first layer.

### Example 9

The apparatus of example 1, wherein the inference model is a convolutional neural network.

### Example 10

At least one non-transitory computer-readable storage medium storing instructions that when executed by a processor circuit cause the processor circuit to: determine a transformation parameter for re-ordering a weight space of an inference model; and generate a transformed weight space based in part on re-ordering weights in the weight space and the transformation parameter.

### Example 11

The at least one computer-readable storage medium of example 10, storing instructions that when executed by the processor circuit cause the processor circuit to determine the transformation parameter based in part on a density of the weight space.

### Example 12

The at least one computer-readable storage medium of example 11, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

### Example 13

The at least one computer-readable storage medium of example 12, wherein the transformed weight space has a size (C*R*S×K), which is less than the size of the weight space.

### Example 14

The at least one computer-readable storage medium of example 10, wherein the re-ordering is defined as T_{θ}{W^{l}}={w_{θ(1)}^{l}, w_{θ(2)}^{l}, w_{θ(3)}^{l}, . . . , w_{θ(k)}^{l}}, wherein w is a layer l of weights in the weight space and θ is the transformation parameter.

### Example 15

The at least one computer-readable storage medium of example 14, wherein the re-ordering changes the operational order of weights in a first layer of the weight space.

### Example 16

The at least one computer-readable storage medium of example 15, wherein the re-ordering further changes the operational order of channels in a second layer of the weight space based in part on the transformation parameter and the re-ordering of the operational order of the weights in the first layer of the weight space.

### Example 17

The at least one computer-readable storage medium of example 16, wherein the re-ordering further changes the operational order of channels in a third layer of the weight space based in part on the transformation parameter and the re-ordering of the operational order of the weights in the first layer of the weight space.

### Example 18

The at least one computer-readable storage medium of example 10, wherein the inference model is a convolutional neural network.

### Example 19

A method, comprising: determining a transformation parameter for re-ordering a weight space of an inference model; and generating a transformed weight space based in part on re-ordering weights in the weight space and the transformation parameter.

### Example 20

The method of example 19, comprising determining the transformation parameter based in part on a density of the weight space.

### Example 21

The method of example 20, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

### Example 22

The method of example 21, wherein the transformed weight space has a size (C*R*S×K), which is less than the size of the weight space.

### Example 23

The method of example 19, wherein the re-ordering is defined as T_{θ}{W^{l}}={w_{θ(1)}^{l}, w_{θ(2)}^{l}, w_{θ(3)}^{l}, . . . , w_{θ(k)}^{l}}, wherein w is a layer l of weights in the weight space and θ is the transformation parameter.

### Example 24

The method of example 23, wherein the re-ordering changes the operational order of weights in a first layer of the weight space.

### Example 25

The method of example 24, wherein the re-ordering further changes the operational order of channels in a second layer of the weight space based in part on the transformation parameter and the re-ordering of the operational order of the weights in the first layer of the weight space.

### Example 26

The method of example 25, wherein the re-ordering further changes the operational order of channels in a third layer of the weight space based in part on the transformation parameter and the re-ordering of the operational order of the weights in the first layer of the weight space.

### Example 27

An apparatus, comprising means arranged to implement the function of any one of examples 19 to 26.

What is claimed is:

1. An apparatus, comprising:
a processor circuit; and
memory coupled to the processor circuit, the memory to store instructions that when executed by the processor circuit cause the processor circuit to:
determine a transformation parameter for re-ordering a weight space of an inference model; and
generate a transformed weight space based in part on re-ordering weights in the weight space and the transformation parameter.

2. The apparatus of claim 1, the instructions when executed by the processor cause the processor to determine the transformation parameter based in part on a density of the weight space.

3. The apparatus of claim 2, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

4. The apparatus of claim 3, wherein the transformed weight space has a size (C*R*S×K), which is less than the size of the weight space.

5. The apparatus of claim 1, wherein the re-ordering is defined as T_{θ}{W^{l}}={w_{θ(1)}^{l}, w_{θ(2)}^{l}, w_{θ(3)}^{l}, . . . , w_{θ(k)}^{l}}, wherein w is a layer l of weights in the weight space and θ is the transformation parameter.

6. The apparatus of claim 5, wherein the re-ordering changes the operational order of weights in a first layer of the weight space.

7. The apparatus of claim 6, wherein the re-ordering further changes the operational order of channels in a second layer of the weight space based in part on the transformation parameter and the re-ordering of the operational order of the weights in the first layer of the weight space.

8. The apparatus of claim 7, wherein the re-ordering further changes the operational order of channels in a third layer of the weight space based in part on the transformation parameter and the re-ordering of the operational order of the weights in the first layer of the weight space.

9. The apparatus of claim 1, wherein the inference model is a convolutional neural network.

10. At least one non-transitory computer-readable storage medium storing instructions that when executed by a processor circuit cause the processor circuit to:
determine a transformation parameter for re-ordering a weight space of an inference model; and
generate a transformed weight space based in part on re-ordering weights in the weight space and the transformation parameter.

11. The at least one computer-readable storage medium of claim 10, storing instructions that when executed by the processor circuit cause the processor circuit to determine the transformation parameter based in part on a density of the weight space.

12. The at least one computer-readable storage medium of claim 11, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

13. The at least one computer-readable storage medium of claim 12, wherein the transformed weight space has a size (C*R*S×K), which is less than the size of the weight space.

14. The at least one computer-readable storage medium of claim 10, wherein the re-ordering is defined as T_{θ}{W^{l}}={w_{θ(1)}^{l}, w_{θ(2)}^{l}, w_{θ(3)}^{l}, . . . , w_{θ(k)}^{l}} wherein w is a layer l of weights in the weight space and θ is the transformation parameter.

15. The at least one computer-readable storage medium of claim 14, wherein the re-ordering changes the operational order of weights in a first layer of the weight space.

16. The at least one computer-readable storage medium of claim 15, wherein the re-ordering further changes the operational order of channels in a second layer of the weight space based in part on the transformation parameter and the re-ordering of the operational order of the weights in the first layer of the weight space.

17. The at least one computer-readable storage medium of claim 16, wherein the re-ordering further changes the operational order of channels in a third layer of the weight space based in part on the transformation parameter and the re-ordering of the operational order of the weights in the first layer of the weight space.

18. The at least one computer-readable storage medium of claim 10, wherein the inference model is a convolutional neural network.

19. A method, comprising:
determining a transformation parameter for re-ordering a weight space of an inference model; and
generating a transformed weight space based in part on re-ordering weights in the weight space and the transformation parameter.

20. The method of claim 19, comprising determining the transformation parameter based in part on a density of the weight space.

21. The method of claim 20, wherein the density is defined as d(k)=Σ_{c}ΣᵣΣₛM(k, c, r, s), where M is a binary mapping of the weight space with size (K×C×R×S), and where C and K are the size of input and output channels in the weight space, and where R×S is the spatial size of each layer of weight space.

22. The method of claim 21, wherein the transformed weight space has a size (C*R*S×K), which is less than the size of the weight space.

23. The method of claim 19, wherein the re-ordering is defined as T_{θ}{W^{l}}={w_{θ(1)}^{l}, w_{θ(2)}^{l}, w_{θ(3)}^{l}, . . . , w_{θ(k)}^{l}}, wherein w is a layer l of weights in the weight space and 0 is the transformation parameter.

24. The method of claim 23, wherein the re-ordering changes the operational order of weights in a first layer of the weight space.

25. The method of claim 24, wherein the re-ordering further changes the operational order of channels in a second layer of the weight space based in part on the transformation parameter and the re-ordering of the operational order of the weights in the first layer of the weight space.
